(19) United States
(12) Patent Application Publication
(10) Pub. No.: US 2026/0018945 A1
(43) Pub. Date: Jan. 15, 2026

(54) TRANSPOLAR MOTOR

(71) Applicants: Alexander Norris Benson, Seattle, WA (US); Frank Michael Washko, Brush Prairie, WA (US)

(72) Inventors: Alexander Norris Benson, Seattle, WA (US); Frank Michael Washko, Brush Prairie, WA (US)

(21) Appl. No.: 19/259,573

(22) Filed: Jul. 3, 2025

Related U.S. Application Data
(60) Provisional application No. 63/668,775, filed on Jul. 9, 2024.

(51) Int. Cl. H02K 1/16; H02K 1/27; H02K 3/12

(52) U.S. Cl. CPC H02K 1/16; H02K 1/27; H02K 3/12

(57) ABSTRACT

Synchronous motors exhibit performance decay beyond their designed power output. To overcome this decay, designers adopt sub-optimal strategies to compensate for the loss of idealized power. The present invention mitigates the need for these strategies by varying the number of poles in the stator through programmatic, electrical, or electromechanical means. In the case of programmatic methods, the solution involves changing the waveform assigned to a set of conductors according to an assignment table. In the case of electrical or electromechanical means, the solution involves a collection of transistors or relays functioning as switches, changing the flow of current through the stator consistent with the same assignment table for programmatic means. Finally, to improve the interaction between rotor and stator, the solution involves several mechanical and electromechanical methods to change the number of poles on a rotor as required.

### CROSS-REFERENCE TO RELATED APPLICATIONS

This application is a non-provisional application based on the provisional patent application U.S. 63/668,775, filed Jul. 9, 2024, which is incorporated herein in its entirety.

### BACKGROUND

The present invention relates generally to electric motors and more particularly to synchronous motors that may change electrical or magnetic pole quantities.

Synchronous motors have become established as the preferred motor in electric vehicle applications. These motors have many features to recommend them, including high power densities, unmatched efficiency, and a wide range of performance without sacrificing efficiency.

Despite their favorable characteristics, synchronous motors experience performance degradation when operating beyond their designed power output. To mitigate this issue, designers often implement sub-optimal strategies to compensate for the loss of idealized power. One approach involves designing a motor with a lower maximum torque than what might be considered optimal, ensuring consistent performance up to the vehicle's maximum anticipated operating speed.

Alternately, a multi-speed transmission can be employed, allowing the motor to function within its efficient speed range while extending the mechanical speed of the drivetrain, like the approach used in internal combustion engines.

In both cases, design compromises are required. In the former case, the motor is over-designed for the application and the cost of reducing transmission requirements are passed onto the motor. In the latter case, multi-speed transmissions are expensive, heavy, and reduce drivetrain efficiency.

### BRIEF SUMMARY OF THE INVENTION

Accordingly, a need exists to improve the performance of a powertrain by reducing the factors contributing to performance degradation at higher speeds while supporting design practices consistent with higher torque motors. Furthermore, what is needed is a method of improving the high-speed performance of synchronous motors by mitigating the primary cause of power factor loss, the rise of electrical frequency at higher speeds.

To overcome the loss of power factor as mechanical speed rises, the present invention provides several possible mechanisms to alter the number of poles within the motor. As a non-limiting example, the present invention provides: a control system paired with a three-phase 8/4 transpolar stator comprising 48 slots and one conductor per slot; a schematic of switching relays capable of switching half of the conductors from their 8-pole configuration to their 4-pole configuration; an 8/4 pole commutated DC-fed synchronous rotor; and a schematic of relays capable of switching the single-phase stator and the aforementioned transpolar rotor. Also provided are a single-phase stator, of similar construction to the three-phase stator, and several 8/4 pole rotors.

### BRIEF DESCRIPTION OF THE DRAWINGS

FIG. 1 is an idealized example of a motor's steady-state output curve.

FIG. 2A is an illustrative example of a motor's behavior within a typical circuit.

FIG. 2B is an illustration of a phase diagram approximating the loading of motor components on a circuit, illustrating the composition of power factor losses.

FIG. 3A is an illustration of a transpolar motor control system for an AC stator in accordance with embodiments of the present invention.

FIG. 3B is an illustration of a transpolar motor control system for a DC-fed rotor in accordance with embodiments of the present invention.

FIG. 3C is an illustration of a transpolar motor control system for a DC stator in accordance with embodiments of the present invention.

FIG. 4 is an example of a typical eight-pole three-phase AC stator.

FIG. 5 is an illustration of a typical four-pole three-phase AC stator.

FIG. 6 is an illustration of a conductor or slot map superimposing a four-pole stator onto an eight-pole stator in accordance with embodiments of the present invention.

FIG. 7 is an illustration of a circuit diagram associated with a switching arrangement for a three-phase transitional pole-pair in accordance with embodiments of the present invention.

FIG. 8 is an illustration of a circuit diagram associated with a switching arrangement for a single-phase transitional pole-pair in accordance with the embodiments of the present invention.

FIG. 9 is an illustration of an eight-pole commutated rotor.

FIG. 10 is an illustration of an eight-pole commutated rotor converted to a four-pole rotor with all-active coils in accordance with embodiments of the present invention.

FIG. 11 is an illustration of an eight-pole commutated rotor converted to a four-pole rotor with half-active coils in accordance with the embodiments of the present invention.

FIG. 12 is an illustration of a circuit to implement the eight-pole commutated rotor converted to a four-pole rotor with all-active coils discussed in FIG. 10, in accordance with embodiments of the present invention.

FIG. 13 is an illustration of a circuit to implement the eight-pole commutated rotor converted to a four-pole rotor with half-active coils of FIG. 11 in accordance with embodiments of the present invention.

FIG. 14 is an illustration of a drawing contrasting eight-and four-pole configurations for a transpolar rotor (intended to be paired with a transpolar stator) in accordance with embodiments of the present invention.

FIG. 15 is an illustration of a drawing of an eight-pole transpolar rotor, with an eight-pole stator in accordance with embodiments of the present invention.

FIG. 16 is an illustration of a drawing of a four-pole transpolar rotor, with a four-pole stator in accordance with embodiments of the present invention.

FIG. 17 is an illustration of a permanent magnet mobility achieved through counterweights and bent sheet metal in accordance with embodiments of the present invention.

FIG. 18 is an illustration of the transpolar rotor components in FIG. 17 in closer detail, in accordance with embodiments of the present invention.

FIG. 19 is an illustration of mobile magnetic material achieved using cams and a collar in accordance with embodiments of the present invention.

FIG. 20 is an illustration of the cam and collar transpole from FIG. 19 in further detail, in accordance with embodiments of the present invention.

FIG. 21 is an illustration of mobile magnetic material using solenoid actuators in accordance with embodiments of the present invention.

FIG. 22 is an illustration of a solenoid-based transpole system in its reduced-pole configuration in accordance with embodiments of the present invention.

FIG. 23 comprises an illustration of a speed-variant compliant mechanism in accordance with embodiments of the present invention.

FIG. 24 is an illustration of the compliant mechanism shown in FIG. 23 in further detail, in accordance with embodiments of the present invention.

FIG. 25 is an illustration of the compliant mechanism from FIGS. 23 and 24 in its high-speed shape, in accordance with embodiments of the present invention.

FIG. 26 comprises an illustration of a speed-variant elastomer, in accordance with embodiments of the present invention.

FIG. 27 is an illustration of a detailed view of the compliant mechanism from FIG. 26, at high-speed, in accordance with embodiments of the present invention.

### DETAILED DESCRIPTION

While the exemplary embodiments illustrated herein may show various features, it will be understood that the different features disclosed herein can be combined to achieve the present invention's objectives.

In an electric motor, the stator is the stationary part housing electric windings (referred to interchangeably with the term “coils”) and creates an electromagnetic field when energized. The poles refer to the magnetic regions within both stator and rotor that interact to produce rotational motion. The number of poles determines the motor's speed and performance characteristics. In emerging applications, such as electric vehicles and industrial automation, balancing pole quantity requires compromises. More poles improve torque and precision but increase losses at high speeds. If the pole quantity is too high, to meet a torque-output target, the motor may stop functioning at higher speeds altogether. Fewer poles enable higher speeds (as shown in EQN 1 below where ω_{mech} refers to the mechanical or physical speed of the motor, ω_{elec} refers to the electrical speed, and nₚₒₗₑₛ refers to the number of poles), but reduce efficiency and torque at lower operational ranges. Designers must carefully optimize pole count to meet demands for power density, efficiency, and reliability in these emerging technologies. The balance of torque requirements with output speed requirements can be considered the characteristic operating conditions of a motor.

$${ω}_{mech} = \frac{2 {ω}_{elec}}{{n}_{poles}} ⇔ \frac{{ω}_{mech} {n}_{poles}}{2} = {ω}_{elec} \qquad ( EQN 1 )$$

The purpose of motor control is to manage the current and phases supplied to the slots and the motor poles. A phase in an electric motor refers to a separate AC voltage and current cycle powering a motor. Single phase motors use one AC cycle, while three-phase motors use three AC cycles. Typically, the cycles of a three-phase motor are sine waves offset by 120 degrees. Motors with more than one phase can be called multi-phase motors and generally exhibit better performance and power efficiency. Slots in an electric motor hold the stator windings and influence how the magnetic field is distributed. Engineers balance slot and pole quantity to optimize performance for different applications.

All electric motor systems use coil windings to create magnetic fields between the stator and the rotor. Some electric motor systems may use permanent magnets to accentuate the magnetic fields between the stator and the rotor.

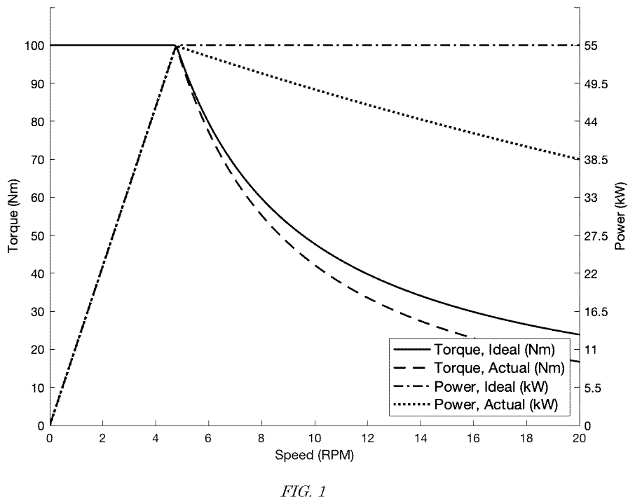

FIG. 1 is an idealized example of a motor's steady-state output curve. An ideal electric motor will exhibit a steady-state power performance curve like the one shown. This curve typically shows a steady increase in output power with a constant torque output up to the maximum power point. Beyond this point, while power output remains constant, torque output begins to decline. In practice, an actual motor's power output will decline after reaching that max power point. There are many sources of loss inside a motor, including winding losses and hysteresis losses (typically iron and core losses); however, the primary source is the degradation of the machine's power factor.

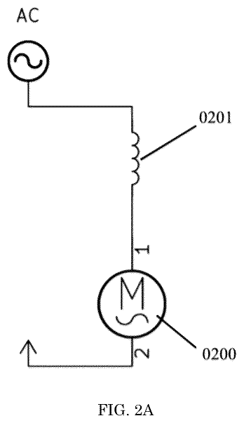

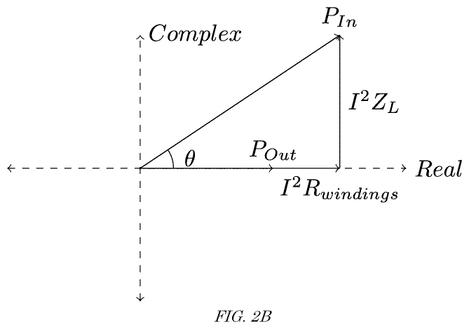

The power factor loss in a motor partially lies in that motors are inductive machines, meaning that they exhibit impedance and performance losses like reactive components. FIG. 2A is an illustrative example of a motor's behavior within a typical circuit. By treating a motor, 0200, as separate from its winding, 0201, but still in series with the motor, we can discuss the power output of the system captured in FIG. 2A. EQN 2 is a simplified expression of the circuit's total inductance, which treats the motor component as providing no impedance, as intended when the windings were separated from the motor. Between EQN 1 and 2, it becomes apparent that the impedance will rise in proportion to frequency due to the complex component, j, Inductance, L, is essential to the performance of a motor, as higher inductance is a factor in higher torque outputs.

$${Z}_{L} = j ω L \qquad ( EQN 2 )$$

To explain the significance of inductance, it is necessary to introduce flux linkage. Flux linkage refers to the total magnetic flux that passes through the coils or windings of a motor and into the rotor, producing torque much like how the teeth of gears transfer force from a driving gear to a driven gear. It is a measure of how much magnetic field is “linked” with the electrical circuit. Higher flux linkage generally leads to stronger motor performance. It relates to inductance in that flux linkage is the proportion of current and inductance.

EQN 1 and EQN 2 indicate that a rise in motor frequency may result in a rise in unproductive impedance. Motor output results from input power minus the aggregated losses. The losses may be due to impedance, core losses, and winding losses, to name a few sources of performance loss. FIG. 2B is an illustration of a phase diagram approximating the loading of motor components on a circuit, illustrating the composition of power factor losses. P stands for power in both FIG. 2B and when used in subsequent equations. Input (e.g., Pᵢₙ) refers to the electrical power supplied to the motor, while output (Pₒᵤₜ) refers to the power delivered by the motor. EQN. 3 is the algebraic expression of the factors captured graphically in FIG. 2B. Combined, they serve as a summary of impedance and power loss.

$${P}_{in} = {V}_{in} {l}_{in} = \sqrt{{( {P}_{output} + 3 {R}_{windings} {I}_{in}^{2} )}^{2} + {( {I}_{in}^{2} {Z}_{L} + {P}_{coreloss} )}^{2}} \qquad ( EQN 3 )$$

The degradation and loss of power due to electrical frequency is a common problem in Electrical Engineering. Power Factor, EQN 4, is a standard shorthand summarizing the relation between the apparent input and the actual output power.

$$P F = \frac{{P}_{out}}{{P}_{in}} \qquad ( EQN 4 )$$

It is worth emphasizing the significance of impedance. Core loss and winding loss may contribute to a reduction in power output. However, the winding loss is strictly resistive and scales linearly with current, while core loss is rarely large enough to account for much power factor degradation. By contrast, impedance is a major contributor to the loss of power. Input power is the magnitude of the real and complex components on the right-hand side of EQN 3. This relationship is also demonstrated in FIG. 2B. As the complex component rises, the power factor begins to degrade. This degradation is exacerbated by the fact that the motor's output power can be considered a remnant; the power remaining once losses are accounted for.

Given that inductive impedance may be a factor in the loss of output power, methods for reducing the rise of inductive impedance would extend an electric motor's usable speed range. As previously mentioned, poles are electrically conductive clusters representing a location where the motor's magnetic fields pull or repel one another. By varying the number of poles in a motor, it may be possible to extend the usable ranges of frequencies of that motor, much like a multi-speed transmission. Such a motor could be called a transpolar motor.

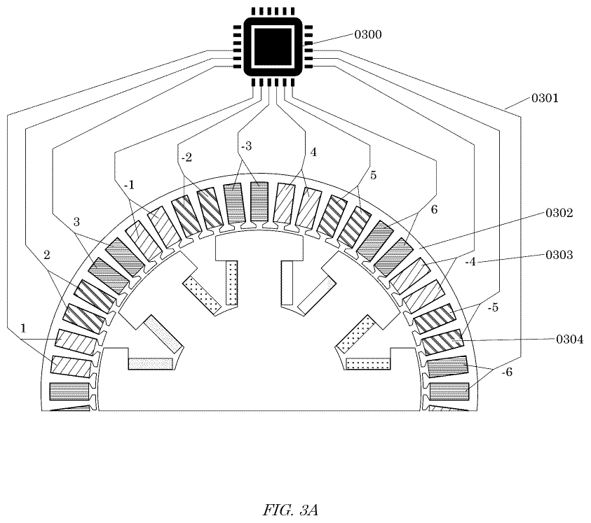

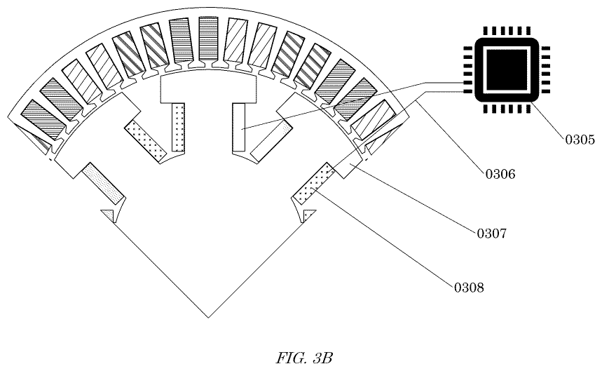

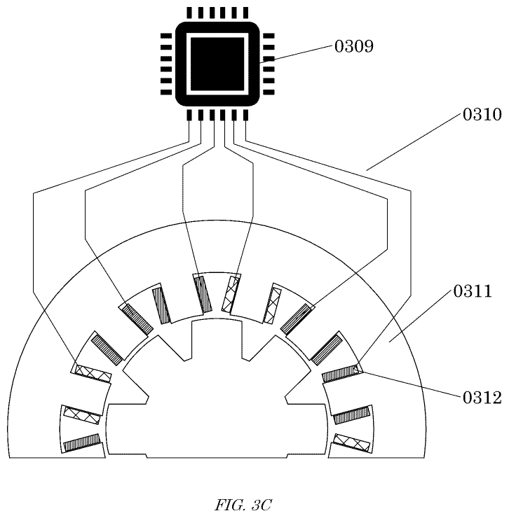

Several methods for reducing that rise in inductive impedance can be implemented through control or switching systems capable of altering the number of effective poles in a motor. For example, FIG. 3A is an illustration of a transpolar motor control system for an AC stator in accordance with embodiments of the present invention. The control system 0300 directs phases of current to defined slot groups via wires 0301 to the stator 0302, and serves as a source of current, referred to as a current source, for all examples herein. Pairs of slots have been assigned pole IDs 0303. The specific phase of each winding 0304 can be shifted by the control system to alter the effective number of poles in the motor.

TABLE 1 has been included to provide an example of the function of the control system. As implemented in FIG. 3A, the pole ID 0303 corresponds to individual phases 0301 managed by the control system. By changing the particular phases directed to a given pole ID, the controller can create the effect of a changing number of poles in the stator. There are many ways to achieve this effect; for demonstrative purposes, three-phase motors have been used as a default. TABLE 1 demonstrates that a six-phase transpolar controller is possible.

TABLE 1
AN ASSIGNMENT TABLE FOR PHASE ID TO THE
BASE 8-POLE MOTOR AND 4-POLE EQUIVALENT

| Pole ID | Higher Pole- | Lower Pole- | Lower Pole-Count, |
|---|---|---|---|
| 0303 | Count Phases | Count Phases | Six-Phase Equivalent |
| 1 | A | A | A |
| 2 | B | A | B |
| 3 | C | B | C |
| −1 | −A | B | D |
| −2 | −B | C | E |
| −3 | −C | C | F |
| 4 | A | −A | −A |
| 5 | B | −A | −B |
| 6 | C | −B | −C |
| −4 | −A | −B | −D |
| −5 | −B | −C | −E |
| −6 | −C | −C | −F |

FIG. 3B is an illustration of a transpolar motor control system for a DC-fed rotor in accordance with embodiments of the present invention. Similar to FIG. 3A, the control system 0305 directs current. The distinction begins in that the current through the wires 0306 is DC and feeds the rotor 0307 rather than the stator. The purpose of the control system 0305 is to manipulate and manage the number of poles in the rotor. In a DC-fed rotor, these poles are a function of the orientation of the electric windings 0308 and the number of poles in the rotor can be changed by strategically altering the direction of flow in the appropriate windings.

FIG. 3C is an illustration of a transpolar motor control system for a DC stator in accordance with embodiments of the present invention. The nature of the invention is flexible in that both AC and DC transpolar motors are possible. To demonstrate, a Variable Reluctance Motor (VRM) is shown. The control system 0309 controls the flow of DC via wires 0310 to the DC stator 0311. Similar to the DC rotor in FIG. 3B, the number of poles in a DC transpolar stator is a direct function of the orientation of the windings 0312. Changing the direction of flow thus alters the effective orientation of a winding. As a result, motor designers can apply the methods outlined below to a broad range of both AC and DC motors, combining DC poles in a stator using the same methods outlined for AC stators.

Some embodiments of the present invention implement methods of varying the pole quantities within an electric motor system. In one embodiment, a system of switches is implemented to vary the number of magnetic poles within the electric motor operation. This approach may be used to vary the number of poles within a single motor, depending on the implementation of the switching system.

In another embodiment of the present invention, the geometry defining the behavior of the permanent magnet fields within the electric motor system can be varied. This variation may be accomplished by varying the position or shielding the permanent magnets within the electric motor system.

Embodiments of the present invention may combine these two approaches (in the above two embodiments) into a single motor system design, which may provide further refinement or control over the output characteristics of the electric motor system. Altering the pole quantity of the stator or the rotor in isolation may introduce unfavorable performance characteristics, such as torque ripple. Aligning shifts in the pole quantity between the stator and rotor will be desirable in applications with harmonic or torque ripple concerns.

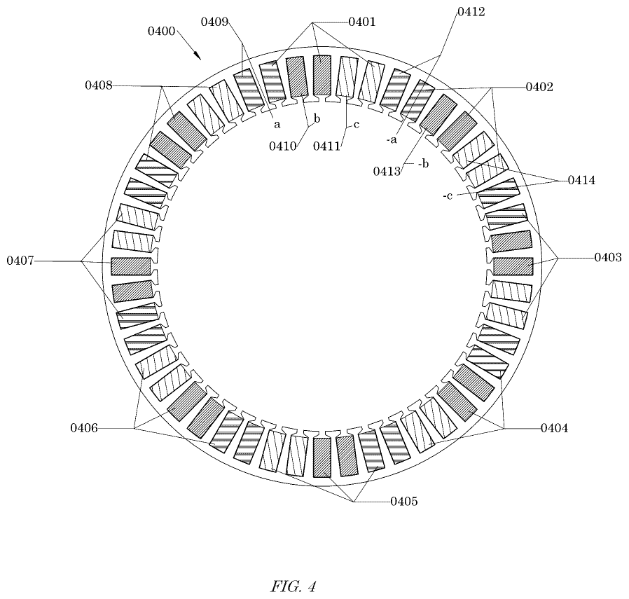

FIG. 4 is an example of a typical eight-pole three-phase AC stator. The figure shows an eight-pole motor, 0400. The coils highlighted in 0401 through 0408 correspond to the eight poles of the motor, in other words, poles 1 through 8. Pairs of coils are highlighted in 0409 through 0411 and correspond to phases a, b, and c, respectively. The coil pairs of 0412 through 0414 correspond to a, b, and c but with the opposite polarity due to the orientation of the coils.

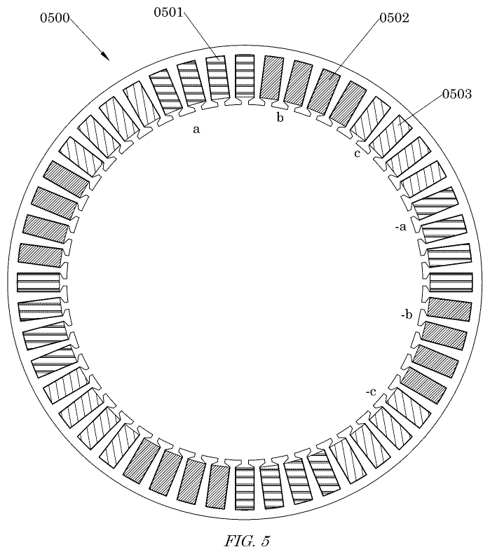

FIG. 5 is an illustration of a typical four-pole three-phase AC stator. It shows a four-pole motor 0500 with one pole comprised of phases 0501, 0502, and 0503 also known as phases A, B, and C.

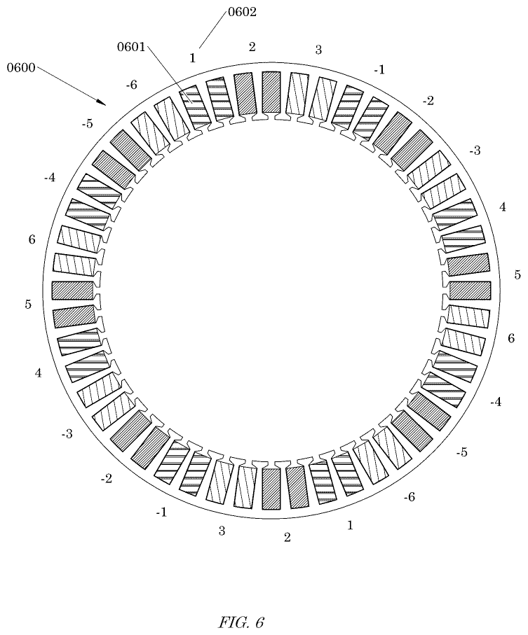

FIG. 6 is an illustration of a conductor or slot map superimposing a four-pole stator onto an eight-pole stator in accordance with embodiments of the present invention. FIG. 6 imagines mapping the eight-pole stator, 0400, onto the four-pole stator, 0500. The result is a transpolar stator, 0600, with many slot pairs, for example 0601, where pole ID 0602 will be defined in the following paragraphs.

In FIG. 6 numbers have been used to construct pole identities rather than letters to improve communication and differentiate between a given pole versus its phase. Pole ID 0602 corresponds to the higher pole count stator configuration. The numbering convention of 1, 2, 3−1,−2,−3, 4 . . . is arbitrary and 1, 2, 3, 4, 5, 6 would be acceptable. There is also no need for the phases to be in a, b, c order: b, a, c or a, c, b are all functionally sequential. Refer to TABLE 1 for an example of how the pole IDs might be mapped from an ID to a phase. Note that in this exemplary embodiment, poles 0601 of the eight-pole stator combine to form the four-pole configuration.

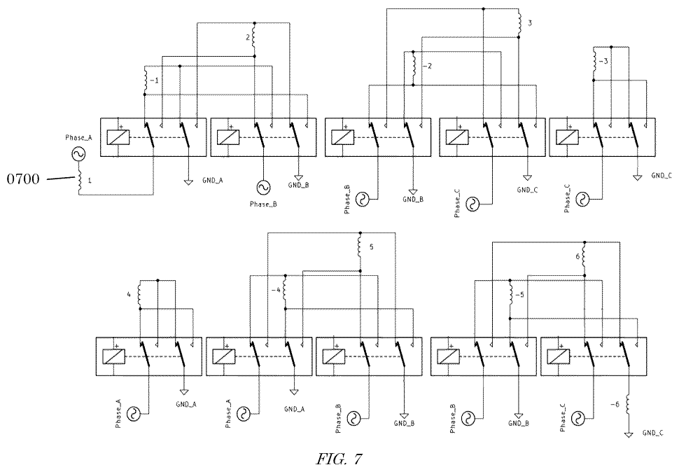

FIG. 7 is an illustration of a circuit diagram associated with a switching arrangement for a three-phase transitional pole-pair in accordance with embodiments of the present invention. The pole-pair enables the stator shown in FIG. 6, with the depicted coils, for example, 0700, corresponding to the coils in stator 0601. By matching phase-specific slots in the circuit to coils in the circuit diagram, a designer can map FIG. 6 to its equivalent, rendered as a single circuit, in FIG. 7. This method is extensible to arbitrary numbers of pole-pairs.

Thus far, the discussion has focused on physical and electronic hardware for a transpolar motor. A programmed inverter could drive a three-phase transpolar stator by mapping specific pole IDs to specific phases, recreating the assignment table from TABLE 1 through a program rather than through switches. A three-phase to six-phase transpolar motor is well suited to this application.

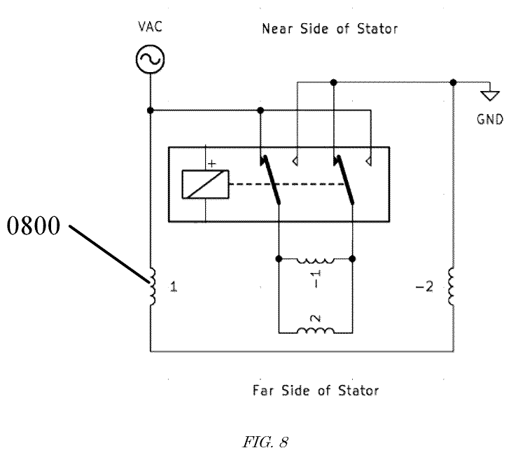

While the examples provided thus far have utilized three-phase configurations, a single-phase transitional pole-pair is possible. FIG. 8 is an illustration of a circuit diagram associated with a switching arrangement for a single-phase transitional pole-pair in accordance with the embodiments of the present invention. FIG. 8 serves the same purpose as FIG. 7. The inductor highlighted in 0800 stands in for winding coils, like the coils in the stator of 0700. In a single-phase motor, TABLE 2 would adapt the pattern from TABLE 1, however, the order of the inner slots has been altered to reflect a single-phase configuration. The approach is extensible to an arbitrary number of pole-pairs.

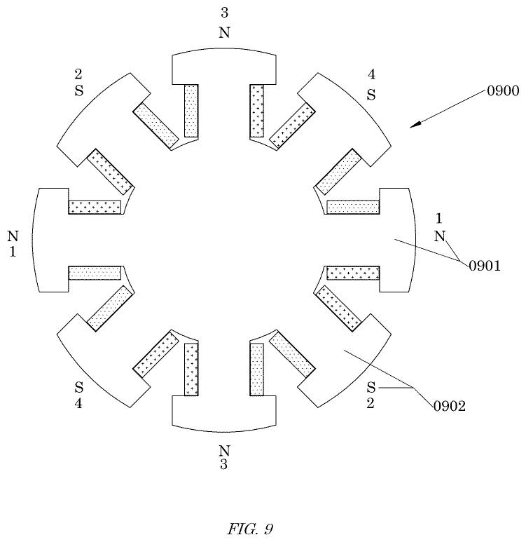

TABLE 2
A MAPPING TABLE TO FIG. 9 FOR
PROGRAMMING OR WIRING PURPOSES

| | Original | New |
|---|---|---|
| Inner | Phase | Phase |
| Pole ID | Orientation | Orientation |
| 1 | Positive | Positive |
| −1 | Negative | Positive |
| 2 | Positive | Negative |
| −2 | Negative | Negative |

The embodiments may require the same formula for slot counts regardless of the specifics of the windings or rotor. The number of slots may be the product of the number of phases multiplied by the maximum number of poles desired, see EQN 5. Multiples of this count are permissible provided the factor k is an integer greater than or equal to one.

$${n}_{slots} = max ( {n}_{poles} ) {n}_{phases} k \qquad ( EQN 5 )$$

The mapping methods in FIG. 6 and transitional pole-pairs from FIG. 7 or FIG. 8 may be implemented for most stators without significant modification to stator geometry or the rotor. Induction motors are a natural fit to this approach. While the motors discussed above have been radial-flux motors, where the magnetic field flows, or radiates, from the axis of rotation outwards and back, a transpolar axial-flux motor, where the magnetic flux flows in the same direction as the axis of rotation, can be constructed using the same mapping tools. It may also be possible to implement the present invention in other motor designs, topologies, or configurations known in the art or after-arising technologies within the art.

Wiring a transpolar stator may create complications depending on the motor topology. All rotors are designed with their stator, and adjusting one without the other introduces performance complications for some topologies. However, it may be possible to implement the present invention with a transpolar stator, transpolar rotor, or a combination of the two.

Some topologies could be configured as transpolar without changes to their rotors. For example, converting an induction stator from a fixed number of poles to a transitional number of poles would require no modifications to the rotor. Similarly, DC reluctance and stepper motors frequently feature mismatched numbers of stator poles and rotor poles. Therefore, it may be possible to implement the present invention in these motor types, and others, as well. In the design of a transpolar configuration of either, it may be sufficient to verify that the rotor satisfies design requirements for all stator configurations.

Both DC and AC synchronous motors could run as transpolar stators with unmodified interior permanent magnet rotors. However, such implementations may reduce the smoothness of a motor's output; torque cogging is a common example. The control mechanisms outlined thus far may need improvement to address this issue. To combat this performance loss, some modifications to the rotor may be implemented in certain embodiments.

Commutated motors, sometimes known as brushed DC and AC motors, possess a means of directly changing the number of poles. FIG. 9 is an illustration of an eight-pole commutated rotor. The rotor from FIG. 9, 0900, is for an AC motor; this solution applies equally to DC motors. For conceptual purposes, it helps to aggregate poles into pairs, pole 0901 and pole 0902, for example. In a transpolar context, a pole-pair can be seen here as two poles in the higher pole quantity configuration that congeal into singular poles in lower pole quantity configurations. Commutated AC motors most often possess matching numbers of poles in the stator and the rotor. In a commutated motor, the rotor pole has highest inductance and flux linkage when a pole is directly aligned with the magnetic field.

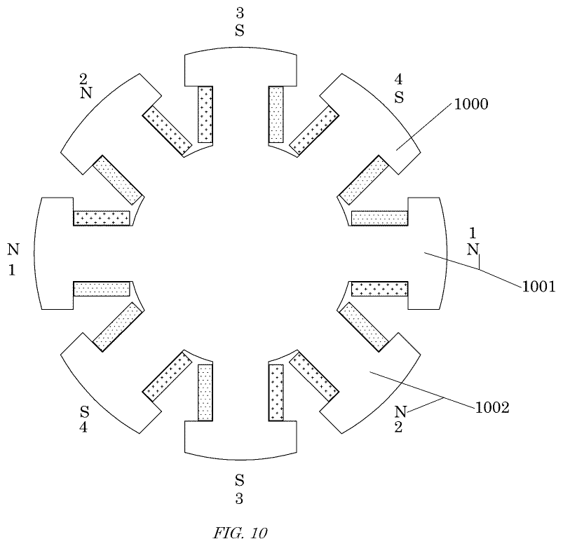

Like the stator, changing the pole quantities of the commutated rotor is a matter of altering the windings. FIG. 10 is an illustration of an eight-pole commutated rotor converted to a four-pole rotor with all-active coils in accordance with embodiments of the present invention. 1000 is the rotor itself. 1001 is an unchanged pole, while 1002 is a pole whose magnetic polarity has flipped.

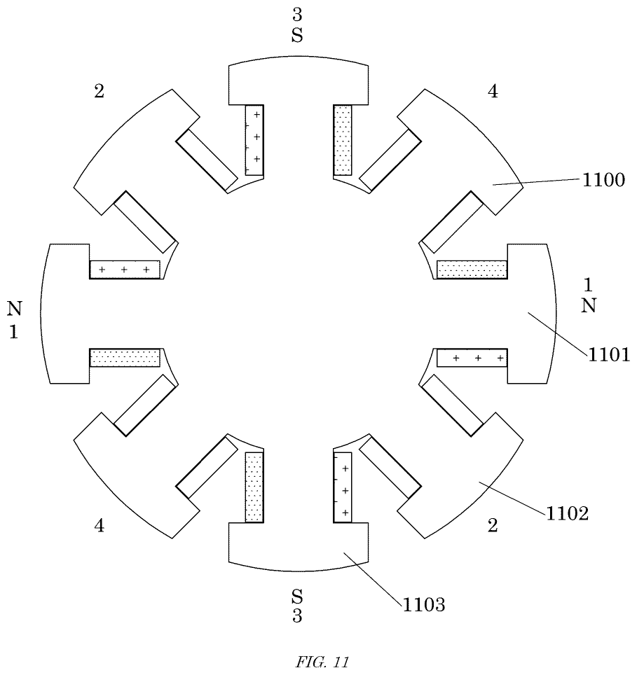

For power consumption, assembly complication, or other reasons it may be preferable to disable some of the poles rather than invert them. FIG. 11 is an illustration of an eight-pole commutated rotor converted to a four-pole rotor with half-active coils in accordance with the embodiments of the present invention. 1100 is the rotor itself. 1101 is an unchanged pole, while 1102 has been switched off. 1103 is a pole from FIG. 9 with its polarity reversed.

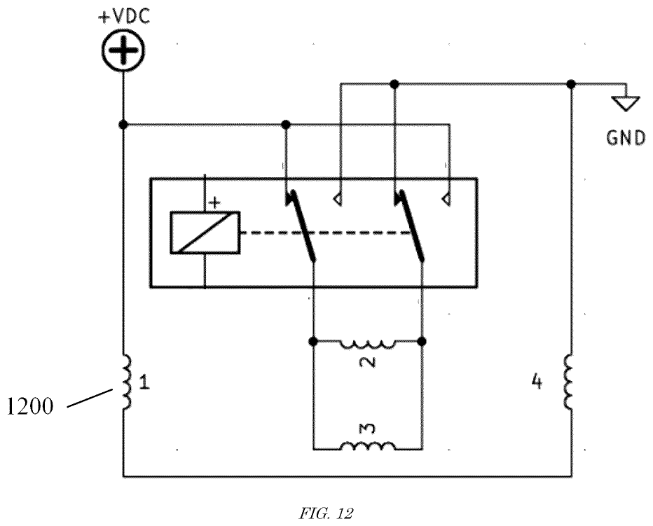

FIG. 12 is an illustration of a circuit to implement the eight-pole commutated rotor converted to a four-pole rotor with all-active coils discussed in FIG. 10, in accordance with embodiments of the present invention. In this illustration, the inductor highlighted as 1200 corresponds to the unchanged pole from FIG. 10 marked as 1001.

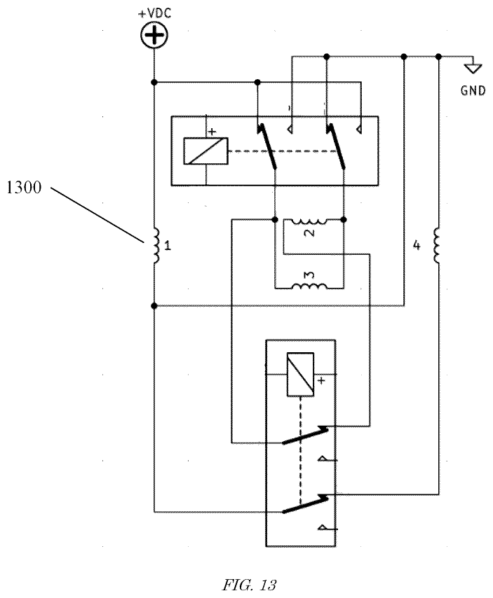

FIG. 13 is an illustration of a circuit to implement the eight-pole commutated rotor converted to a four-pole rotor with half-active coils of FIG. 11 in accordance with embodiments of the present invention. In this illustration, the inductor highlighted in 1300 corresponds to the unchanged pole from FIG. 11, 1101.

Motors with permanent magnets in their rotors, typically referred to as permanent magnet motors, are popular for their power density. From a transpolar perspective, a standard permanent magnet rotor may limit the functionality of the transpolar motor, given that the permanent magnet material cannot alter its poles with a simple switch. Mechanical solutions must be defined.

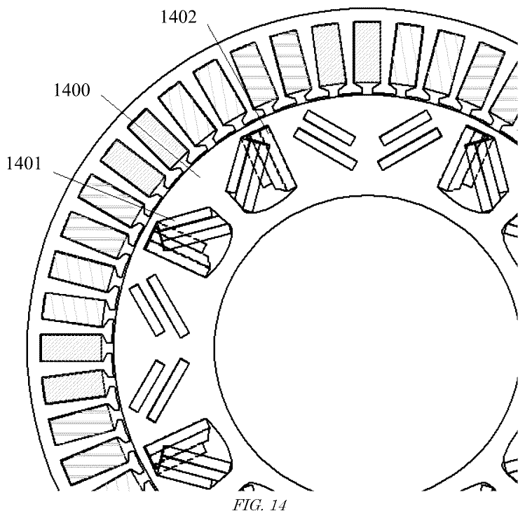

FIG. 14 is an illustration of a drawing contrasting eight-and four-pole configurations for a transpolar rotor (intended to be paired with a transpolar stator) in accordance with embodiments of the present invention. FIG. 14 assumes a stator wired to support multiple pole quantities paired with a rotor with mobile magnetic material, seen as pole 1400, and demonstrates an idealization of the transpolar rotor. Mobile permanently magnetic material, envisioned in the magnetized assemblies in 1401 and 1402, advantageously concentrates magnetic flux and improves a rotor's inductance by mitigating the electrical steel's saturation.

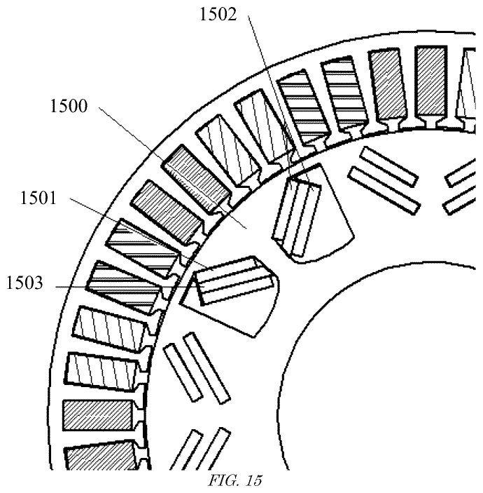

FIG. 15 is an illustration of a drawing of an eight-pole transpolar rotor, with an eight-pole stator in accordance with embodiments of the present invention. FIG. 15 demonstrates a pole, 1500, in the high-pole quantity configuration. The rotor's mobile magnetic assemblies, 1501 for example, utilize mobile magnets, oriented at angles closely resembling that of similar Double-V configurations. The mobile magnets 1502 might be mounted to a sheet of Non-Grain Oriented Electrical Steel (NGOES) or structural steel 1503.

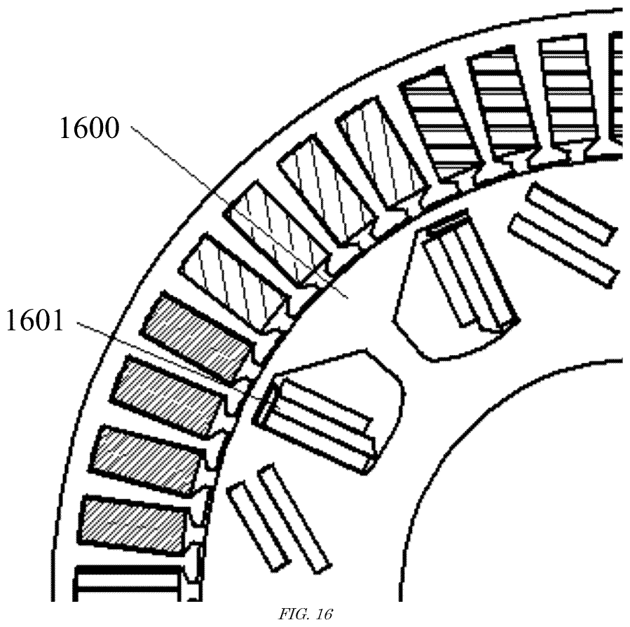

FIG. 16 is an illustration of a drawing of a four-pole transpolar rotor, with a four-pole stator in accordance with embodiments of the present invention. FIG. 16 demonstrates the same geometry from 1500, but no longer a pole. The former pole, now 1600, and magnets, now captured as a bundle in 1601, have rotated as a unit to construct a lower pole quantity, thus changing the magnetic flux pattern. This would be intended for a higher-speed domain in this context. The mobility of the magnets, as illustrated, relies on mechanisms external to the illustration and will be explored in the following paragraphs and figures.

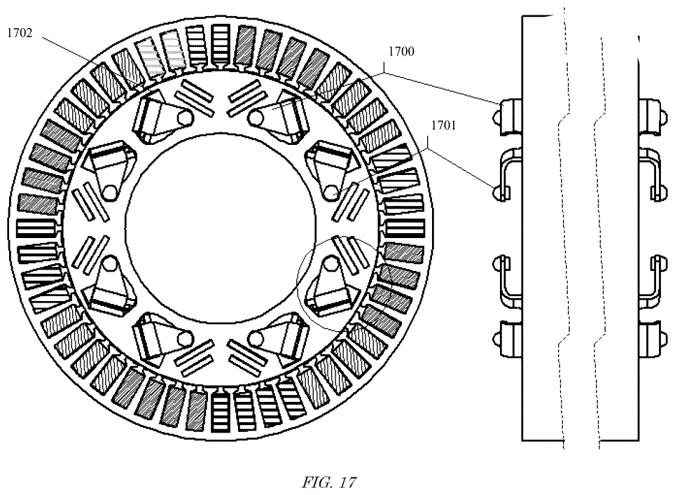

FIG. 17 is an illustration of a permanent magnet mobility achieved through counterweights and bent sheet metal in accordance with embodiments of the present invention. FIG. 17 demonstrates a mobile pole assembly, 1700, comprised of a counterweight 1701 extending beyond the rotor, shifting the effective center of mass of the magnets and electrical steel in the mobile poles. At low speeds, the magnets are coerced into the low-speed configuration by a spring 1702 and held in the high-speed configuration by the centrifugal force of the motor's rotation.

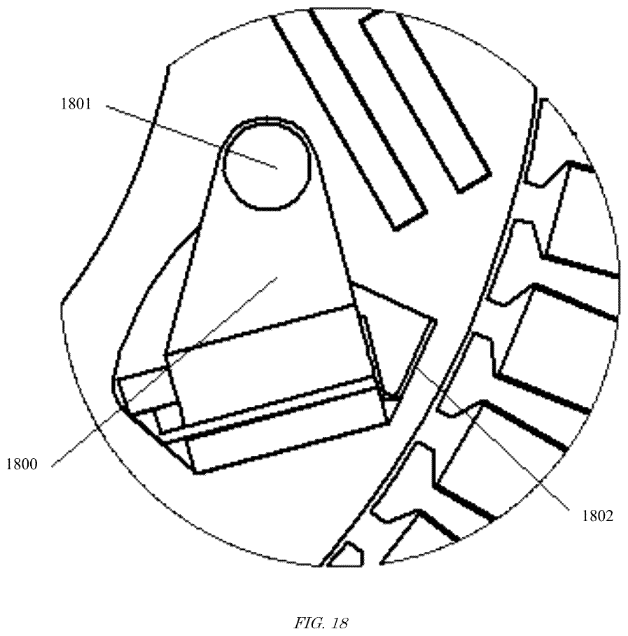

FIG. 18 is an illustration of the transpolar rotor components in FIG. 17 in closer detail, in accordance with embodiments of the present invention. FIG. 18 is intended to demonstrate the assembly, 1800, more closely by providing a clear view of the counterweight, 1801, and spring, 1802.

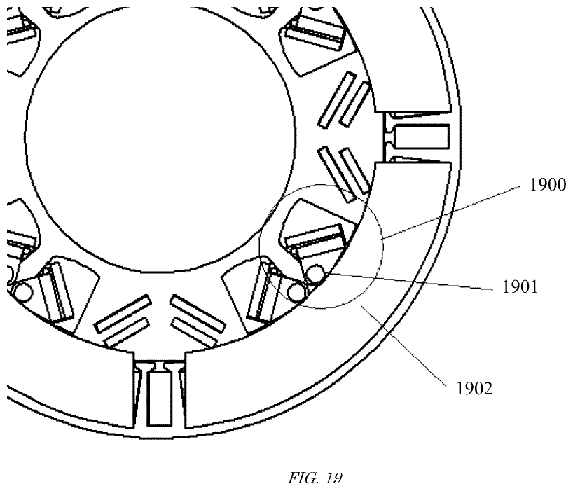

FIG. 19 is an illustration of mobile magnetic material achieved using cams and a collar in accordance with embodiments of the present invention. FIG. 19 demonstrates a second mechanism, circled as a pole-halve, 1900. The mechanism is comprised of a cam 1901 and a collar 1902 mechanism. At high speeds, the collar 1902 constricts and holds the magnets in their high-speed configuration. The mechanism could be inverted to constrict at low speeds by moving the cam to the other side of the hinge.

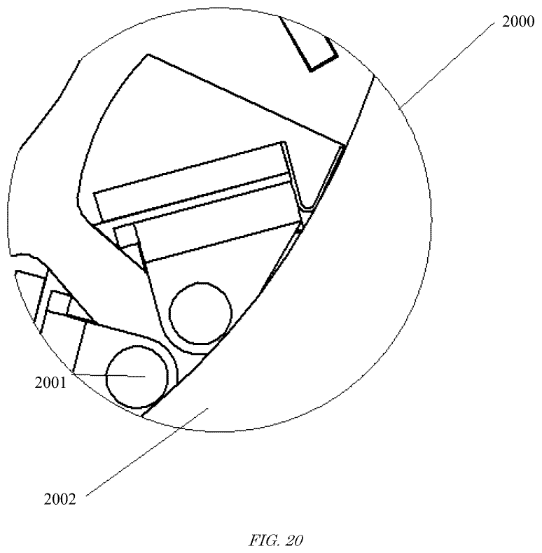

FIG. 20 is an illustration of the cam and collar transpole from FIG. 19 in further detail, in accordance with embodiments of the present invention. It provides closer visual detail of the components. 2000 is the pole-halve from 1900, 2001 is the camshaft of 1901, and 2002 is the collar from 1902.

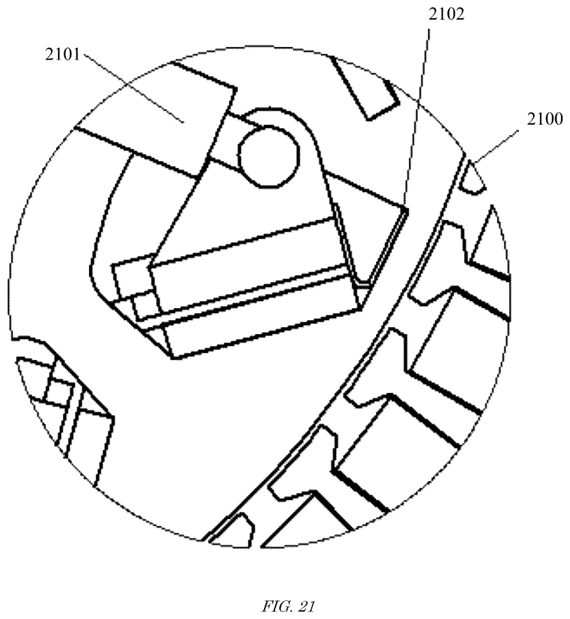

FIG. 21 is an illustration of mobile magnetic material using solenoid actuators to achieve eight rotor-poles in accordance with embodiments of the present invention. FIG. 21 creates a mobile pole-halve, 2100, via a solenoid, 2101, to vary the position or orientation of the permanent magnets in the rotor or stator. The actuators are powered using commutated power; both DC and AC can be used with solenoid actuators. Here, a solenoid may be actuated without the use of spring, though a hinge, 2102, is still necessary to change the permanent magnet position or orientation.

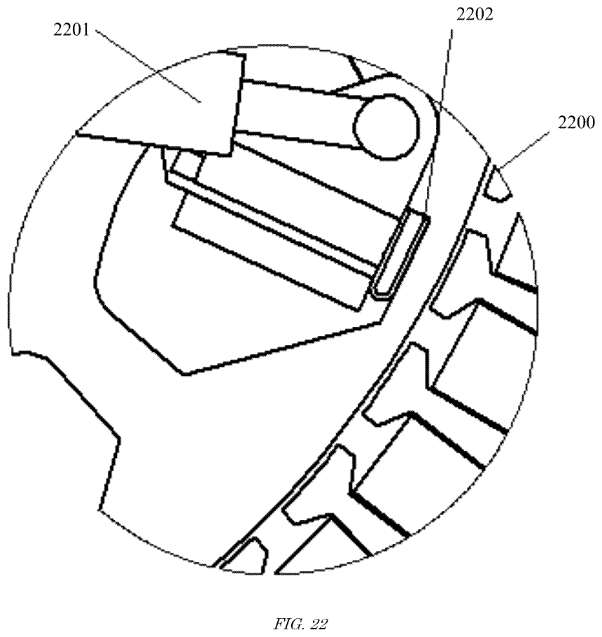

FIG. 22 is an illustration of a solenoid-based transpole system in its reduced-pole configuration in accordance with embodiments of the present invention. FIG. 22 visualizes the actuation of the halve, 2200. In this figure, the solenoids have been extended to alter the locations of the magnets, 2201. Rotation is enabled with hinges, 2202. Like FIG. 19, the geometry may be adjusted or flipped to match a different duty cycle.

In yet other embodiments, mechanical alternatives may use mobile flux barriers rather than moving permanent magnetic materials. A flux barrier is a designed gap in rotor geometry that serves to advantageously direct the flow of magnetic flux in a rotor. It is, in other words, a magnetic flux vane formed by removing permeable material from an otherwise permeable section. Like an aerodynamic vane changing geometry depending on the air or ground speed of the vehicle, a flux barrier can be designed to flex or move depending on the motor's speed. In the low-speed domain, flux may be conducted advantageously through every pole, whereas, at high speeds, half the poles will be blocked.

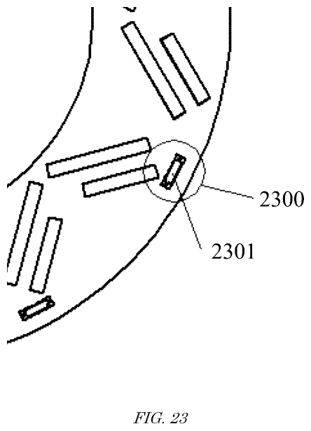

FIG. 23 comprises an illustration of a speed-variant compliant mechanism in accordance with embodiments of the present invention. FIG. 23 explores a compliant mechanism, 2300, achieved via subtraction of NGOES to form a mass located in between sections of more flexible electrical steel. The mechanism, 2301, operates by balancing the spring coefficient of the feature against the centrifugal force generated by the rotating motor.

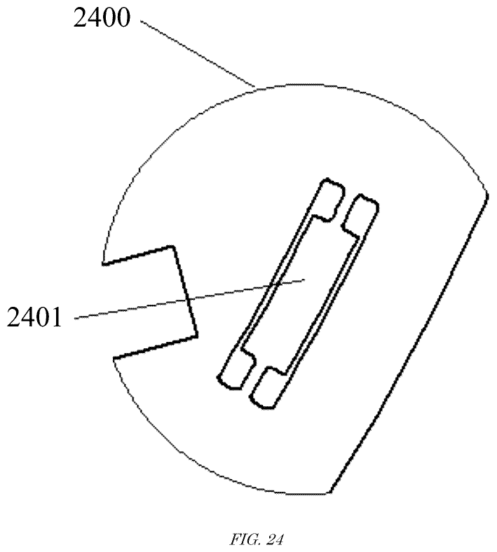

FIG. 24 is an illustration of the compliant mechanism shown in FIG. 23 in further detail, in accordance with embodiments of the present invention. FIG. 24 details the mechanism, 2400, showing the mass, 2401, roughly equidistant between the flux gaps.

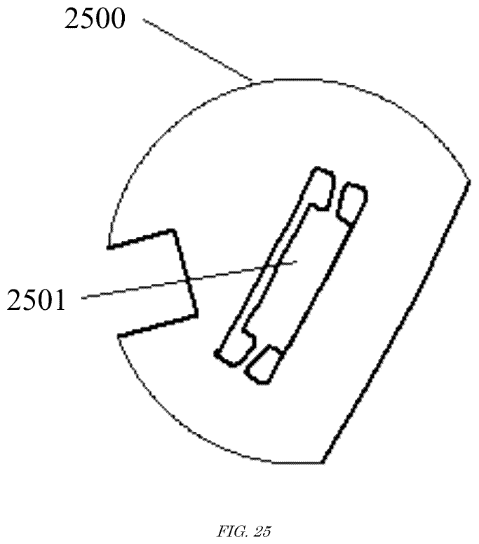

FIG. 25 is an illustration of the compliant mechanism from FIGS. 23 and 24 in its high-speed shape, in accordance with embodiments of the present invention. FIG. 25 models the mechanism, 2500, at higher speeds. In this situation, the mass, 2501 formerly 2401, has deflected outward due to the centrifugal force. In FIG. 25, the larger flux gap reduces the magnetic flux through that gap, altering the flux linkage of the rotor and the stator. As a result, the magnetic flux pattern through the rotor has been varied.

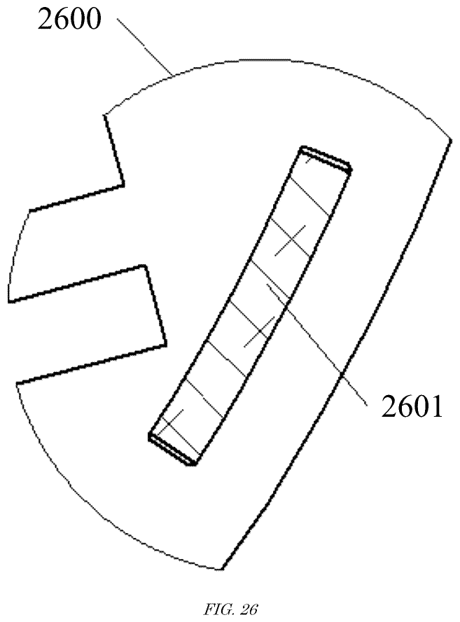

FIG. 26 comprises an illustration of a speed-variant elastomer, in accordance with embodiments of the present invention. FIG. 26 embodies an elastomeric system, 2600, comprised of a compliant barrier formed from a magnetically permeable elastomeric pad, 2601. As envisioned, the elastomeric material will conduct magnetic flux optimally at low speeds, as no gap will form in the rotor.

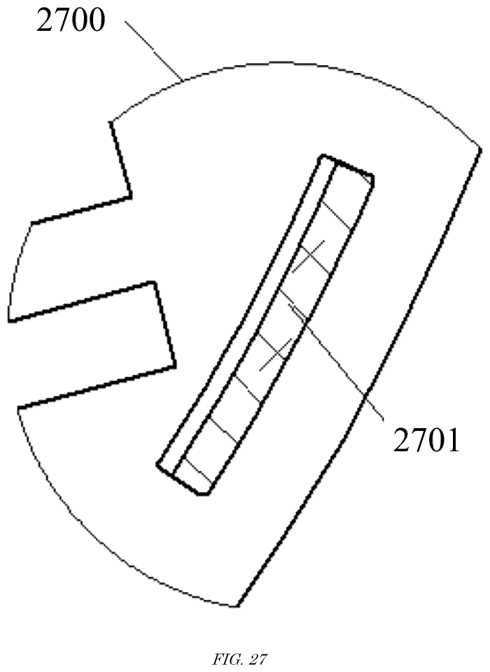

FIG. 27 is an illustration of a detailed view of the compliant mechanism from FIG. 26, at high-speed, in accordance with embodiments of the present invention. FIG. 27, demonstrates the system, 2700, at higher rotation speeds. In this condition, the elastomeric pad, 2701 formerly 2601, has compressed to form a flux gap. The gap blocks the flow of magnetic flux at high speeds and, in doing so, alters the effective number of poles in the rotor.

Any combination of the above features and options could be combined into various embodiments. It is apparent that there is provided in accordance with the present disclosure, improved electric motors. While this invention has been described in conjunction with several embodiments, it is evident that many alternatives, modifications, and variations would be, or are apparent to, those of ordinary skill in the applicable arts. Accordingly, applicants intend to embrace all such alternatives, modifications, equivalents and variations that are within the spirit and scope of this invention.

What is claimed is:

1. An electric motor with a variable number of poles, the electric motor comprising:
a stator;
a rotor positioned within the stator;
a plurality of coil windings configured to generate a magnetic flux between the rotor and the stator;
a current source; and
a control system configured to direct current from the current source to the plurality of coil windings, wherein specific phases of the current are directed to specific sets of the plurality of the coil windings, and wherein the specific sets of the plurality of windings are varied with one or more operating conditions of the electric motor.

2. The electric motor of claim 1, wherein the coil windings are on the stator.

3. The electric motor of claim 1, wherein the coil windings are on the rotor.

4. The electric motor of claim 1, wherein the electric motor is a multi-phase motor.

5. The electric motor of claim 1, wherein the electric motor is a permanent magnet motor.

6. The electric motor of claim 1, further comprising respective slots for each of the plurality of coil windings, wherein each of the plurality of coil windings are separate from each other, and wherein sets of the respective slots represent poles of the electric motor.

7. The electric motor of claim 6, wherein the control system uses switches to direct different phases of current to different slots of the respective slots to change the poles of the electric motor.

8. The electric motor of claim 6, wherein the control system is configured to direct different phases of current from the current source to different sets of the respective slots depending on the one or more operating conditions of the electric motor, such that a number of the poles of the electric motor changes with the operating conditions of the electric motor.

9. The electric motor of claim 8, wherein the poles are on the stator.

10. The electric motor of claim 1, further comprising permanent magnets attached to the motor, wherein a magnetic flux pattern generated within the electric motor can be varied.

11. An electric motor with a variable magnetic flux pattern, the electric motor comprising:
a stator;
a rotor positioned within the stator;
coil windings configured to generate a magnetic flux between the rotor and the stator;
permanent magnets attached to the rotor, wherein the magnetic flux pattern generated within the electric motor can be varied;
a current source; and
a control system configured to direct current from the current source to the coil windings.

12. The electric motor of claim 11, further comprising at least one spring configured to modify a position of at least one permanent magnet.

13. The electric motor of claim 11, further comprising at least one spring configured to modify an orientation of at least one permanent magnet.

14. The electric motor of claim 11, further comprising at least one compliant barrier configured to modify a flux pattern of at least one permanent magnet.

15. The electric motor of claim 11, further comprising at least one compliant barrier configured to modify an orientation of at least one permanent magnet.

16. The electric motor of claim 11, further comprising at least one solenoid configured to modify a position of at least one permanent magnet.

17. The electric motor of claim 11, further comprising at least one solenoid configured to modify an orientation of at least one permanent magnet.

18. The electric motor of claim 11, wherein the control system is configured to direct current from the current source to the coil windings, wherein specific phases of the current are directed to specific sets of the coil windings, and wherein those sets of the coil windings are varied with one or more operating conditions of the electric motor.

19. The electric motor of claim 18, further comprising slots for separate coil windings, wherein sets of the slots represent poles of the electric motor, and wherein the control system is configured to direct different phases of current to different sets of slots depending on the one or more operating conditions of the electric motor, and wherein a number of the poles of the electric motor changes with the one or more operating conditions of the electric motor.

20. The electric motor of claim 18, further comprising slots for separate coil windings, and wherein sets of slots represent poles of the electric motor, and further wherein the control system uses switches or similar control mechanisms to direct different phases of the current to different slots to change the poles of the motor.
